(19) United States
(12) Patent Application Publication
(10) Pub. No.: US 2018/0005193 A1
(43) Pub. Date: Jan. 4, 2018

(54) METHOD AND APPARATUS FOR PROVIDING ON-DEMAND SCHEDULING AND TRANSFER SERVICES FOR LIABILITY TRANSFERS

(71) Applicant: 4Demand LLC, Addison, IL (US)

(72) Inventors: Shellie Crandall, Oak Park, IL (US); Brion T. Levine, Wheaton, IL (US)

(73) Assignee: 4Demand LLC, Addison, IL (US)

(21) Appl. No.: 15/200,309

(22) Filed: Jul. 1, 2016

(51) Int. Cl. G06Q 10/10; G06Q 40/02

(52) U.S. Cl. CPC G06Q 10/1093; G06Q 40/02

(57) ABSTRACT

Apparatus and methods are described that provide on-demand scheduling and transfer services for liability transfers. The apparatus and methods allow a customer to schedule, on-demand, liability transfers with a provider where a liability transfer may be a liability pickup, such as for a customer deposit, or a liability delivery, such as for a change order. The method and apparatus allow for verifying provider availability at the requested location and time, and may also provide for confirmation of the liability transfer. The methods and apparatus may also verify a requested liability transfer amount with an actual liability transfer amount. In addition, the methods and apparatus may employ business-to-business (B2B) electronic payments to transfer funds in, or out of, bank accounts.

### BACKGROUND OF THE DISCLOSURE

Although a business's customer sometimes pays for goods or services received using an electronic service such as a credit card payment system, many customers today still prefer to pay with a more material form of money such as currency, bills, cash, coins, checks, or notes. As such, businesses often receive compensation from their customers in exchange for sold goods and services. Businesses may also use these more material forms of money in their day to day operations. As such, business often arrange for the pick-up of such money, known as customer deposits (e.g., commercial customer deposits), or liability (e.g., anything of value), to their bank for deposit into an account. Although the business may decide to deliver such customer deposits to their bank themselves (e.g., by driving received currency to their bank), a business may instead hire a carrier service, such as an armored carrier service, that makes scheduled stops at a business's location to pick up the customer deposits. The business may schedule the armored carrier service to stop at the business's location once a week, for example. After picking up the customer deposits at a business's location, the armored car will, after possibly making additional stops at other business locations, deliver the customer deposits to an armored depot (e.g., bank vault, cash vault).

At the armored depot, customer deposits received from various businesses that may have been collected along various carrier routes are consolidated into one or more bags destined for a particular bank. For example, customer deposits destined for Bank A may all be placed in “Bank A” bags, customer deposits destined for Bank B may be placed in “Bank B′ bags, and so forth. As such, a consolidated bag for a particular bank may include multiple bags where each bag is associated with a different customer. These consolidated bags may then be delivered to a bank vault which may be located in one of three places. First, the consolidated bags may be delivered to a bank vault that is outsourced to a carrier service that may be located at an armored depot location associated with the carrier service that received the consolidated bags from the businesses. For example, Bank A may outsource a bank vault at an armored depot location that also provides a customer deposit pick-up service to receive consolidated bags destined for Bank A. Second, a bank may instead outsource a bank vault at another armored depot (e.g., such as one not associated with the armored carrier service delivering the consolidated bag) where delivery of consolidated bags may be received. Third, a bank may own and operate its own bank vault where delivery of consolidated bags may be received. In the event that a consolidated bag is to be delivered to one of the latter two bank vaults, a shuttle truck is typically used for the consolidated bag delivery from the armored depot to the corresponding bank vault.

Once received at a bank vault, the consolidated bag is opened and the number of customer deposits received are counted and compared against an expected number of customer deposits to be received at the bank vault. Once verified, the customer deposits are sent to a processing teller to process the customer deposits. The processing teller opens the consolidated bags, verifies the contents of the consolidated bags (e.g. counting cash, coin, checks), and updates a money room processing platform with credit/debit information. At some point in time (e.g., midnight), the credit/debit is transmitted from the money room processing platform to the bank system The bank system processes the credit/debit information and credits customer bank accounts based on the credit/debit information.

In addition, a business may need to keep currency in various forms, such as various bill or coin denominations, to allow them to return to a customer a correct amount of change. Although the business may decide to obtain such currency from their bank themselves (e.g., by driving currency to their bank and exchanging it for various bill or coin denominations), a business may instead hire a carrier service that makes scheduled stops at a business' location to deliver such change (e.g., liability delivery). Prior to the carrier service delivering the change, a business would place what is known as a “change order” with a bank. Once a change order is placed, a bank will have funds removed from a business's corresponding bank account for a value corresponding to the change requested. The bank consolidates customer change order requests and sends a customer change order request, including a denomination break down (e.g. currency, coin), and the total amount of the change order request to the bank vault (e.g. outsourced armored carrier or internal vault). Once the customer change order fulfillment request is received at the bank vault, the bank vault teller will fill customer requests by removing currency from the bank vault in the requested denomination and amounts, loading currency into a change order security bag which identifies the customer a change order is associated with, and placing them in a consolidated bag. Once all commercial customer change orders are fulfilled and consolidated for carrier receipt, the consolidated bags remain at the bank vault until the carrier arrives and receives custody of the consolidated bags. The carrier arrives and verifies that the number of commercial customer change orders received in the consolidated bag is the number of commercial customer change orders given to them by the bank vault. The carrier place the consolidated bags on a delivery schedule along a carrier route. In some cases, a business may schedule for a pickup of a customer deposit and delivery of a change order, where the same armored car picks up the customer deposit and delivers the change requested in the change order to the customer during the same scheduled stop.

These practices, however, present various issues. First, for customer deposits, there may be long delays between when a pickup is necessitated and when a pickup is scheduled. For example, if a business has scheduled an armored carrier service to pick up their customer deposits once a week, there may be up to a seven day delay between when a customer pays for services or goods and when a customer deposit is picked up by the carrier service. In addition, once the customer deposit is picked up by the armored carrier service, there may be a multiple day delay before those funds are made available to the business. Moreover, the customer deposits are handled at many levels (e.g., at bank vault, on shuttle truck, by processing teller, etc.) which increases security risk. Similar disadvantages are present with the placement of change orders. For example, once a change order is placed and funds are withdrawn from a business' bank account, there may be a multi-day delay before receiving the requested change order. In addition, these practices require overhead work, such as the auditing of armored carrier invoices and bank invoices to make sure deposits and pickups are accounted properly for, and the managing of armored carrier services such as carrier performance and costs. As such, there are opportunities to improve the way liabilities are exchanged (e.g., received or delivered) between providers, such as armored carrier service providers, and customers, such as businesses.

### SUMMARY OF THE DISCLOSURE

The disclosure relates generally to apparatus and methods that provide scheduling and transfer services for liability transfers and, more particularly, for providing on-demand scheduling and transfer services for liability transfers utilizing one or more electronic devices. The apparatus and methods allow a customer, such as a business, to schedule, on-demand, a liability transfer with a provider where the liability transfer may be a liability pickup, such as for a customer deposit, or a liability delivery, such as for a change order, by way of an on-demand liability transfer scheduling request. The on-demand liability transfer scheduling request may request for a liability transfer to be scheduled at a particular location for a more immediate time (e.g., now, or in an hour), or for a future time (e.g., next Friday). Time, as used herein, may include one or more of a particular date, a particular day of the week, a time of day, or any suitable indication of a particular future time, include a time range (e.g., from 3:00 pm to 4:00 pm, from Monday at 5:00 pm to Tuesday at 7:00 am). The method and apparatus allow for verifying provider availability at the requested location and time, and may also provide for confirmation of the liability transfer. For example, the provider may operate a multitude of vehicles in a given geographic area. Given various metrics such as, for example, current location of the vehicles (obtainable via, for example, the Global Positioning System (GPS)), geographic territory, expected location of the vehicles, vehicle operation hours, funds availability on the vehicle, distance and drive time required to travel to a customer liability transfer location and others, the methods and apparatus may determine whether a vehicle will be available at a requested time and location.

The methods and apparatus may also provide for verification of a requested liability transfer amount (e.g., value) and an actual liability transfer amount. For example, the methods and apparatus may determine whether a liability transfer amount received at a liability pickup (e.g., the picking up of a customer deposit) is equal to (e.g., matches) a requested amount and provide an indication of that determination. In addition, the methods and apparatus may employ business-to-business (B2B) electronic payments to transfer funds in, or out of, bank accounts. B2B electronic payments, as recognized in the art, are electronic payments from one bank account to another bank account. Funds are withdrawn from a paying account and funded into a receiving account. For example, B2B electronic payments may include Automatic Clearing House (ACH) payments, direct electronic payments from a bank account at one bank to another bank account at the same bank, or any other electronic funds transfer, among others as recognized in the art.

Briefly, an electronic device associated with a provider for an on-demand scheduling service for a liability transfer receives, from an electronic device associated with a customer, an on-demand liability transfer scheduling request for the liability transfer. The electronic devices may be a workstation, computer, an electronic mobile device, a wireless mobile device, a cell phone, a tablet, a laptop, portable media device, in-vehicle display system, an ATM machine, a parking meter, a gaming device such as a video gaming terminal, a redemption terminal, any electronic machine that dispenses or receives money, or any other suitable electronic device. The on-demand liability transfer scheduling request may be associated with a requested time and a requested location for the liability transfer, and may also be associated with an amount of liability (e.g., cash, coin). For example, the on-demand liability transfer scheduling request may be a message, sent over one or more networks, such as the Internet, from a customer's electronic device to a provider's electronic device. The on-demand liability transfer scheduling request may include a requested time and a requested location for the liability transfer. In one example, the on-demand liability transfer scheduling request includes an amount of the liability transfer.

In one example, the on-demand liability transfer scheduling request is a request for a liability pickup, such as a pickup of cash. The on-demand liability transfer scheduling request may be associated with a pickup location and an amount of liability. The amount of liability to be picked up may or may not be known at the time of the request. For example, the on-demand liability transfer scheduling request may include a customer's location of where to pickup the liability. The on-demand liability transfer scheduling request may also identify the amount of liability to be picked up by the provider. In one example, although the on-demand liability transfer scheduling request is associated with an amount of liability, the amount of liability is not identified in the on-demand liability transfer scheduling request.

In another example, the on-demand liability transfer scheduling request includes a change order request where, in this example, liability, such as cash, is to be delivered to (e.g., dropped off at) a customer's location. For example, the on-demand liability transfer scheduling request may identify an amount of liability to be delivered to a customer by a provider at a delivery location. Upon transferring (e.g., delivering) the liability to the customer, the provider may submit (e.g., input) the amount of the liability transferred to the customer to an electronic device associated with the provider, such as a tablet operated by a provider's vehicle driver. The electronic device may then transmit a confirmation of the liability amount transferred to another electronic device, such as another electronic device associated with the provider, which may be located at a provider's office.

In another example, the on-demand liability transfer scheduling request is a change order request for delivery of change, such as for delivery of an amount of liability in particular denominations. The on-demand liability transfer scheduling request may be associated with a delivery location and an amount of liability. For example, the on-demand liability transfer scheduling request may include a customer's location of where to deliver (e.g., drop-off) the liability. The on-demand liability transfer scheduling request may also identify the amount of liability to be delivered to the customer.

The electronic device associated with the provider may verify that the provider is available for the liability transfer at the requested time and the requested location to determine a scheduled time and scheduled location for the liability transfer. For example, if a provider vehicle is available for the liability transfer at the requested time and the requested location, the electronic device associated with the provider may schedule the liability transfer at the requested time and requested location to that provider vehicle. If, however, no provider vehicles are available for the liability transfer at the requested time and the requested location, the electronic device associated with the provider may either deny the on-demand liability transfer scheduling request, or may schedule the liability transfer at a different time or a different location.

In one example, the electronic device associated with the provider provides to the electronic device associated with the customer alternate times for the liability transfer. For example, the electronic device associated with the provider may provide to the electronic device associated with the customer a plurality of available times for the liability transfer. In one example, the plurality of available times for the liability transfer may be based on the requested time and the requested location for the liability transfer. For example, the plurality of available times for the liability transfer may include times near a requested time. For example, if a requested time was Friday at 3:00 pm, the plurality of available times may include Thursday at 3:00 pm and Friday at 4:00 pm. The electronic device associated with the customer may then receive an indication of a selection (e.g., a user selects) of at least one selected date and at least one selected time for the liability transfer from the plurality of available times. The selected date and time may include, for example, at least one future date. The selection of at least one selected date and one selected time for the liability transfer may then be transmitted by the electronic device associated with the customer to the electronic device associated with the provider.

In one example, the electronic device associated with the provider provides to another electronic device associated with the provider an on-demand liability transfer scheduling order. For example, once provider availability has been verified, an on-demand liability transfer scheduling order may be transmitted from an electronic device located at a provider's office to another electronic device. The other electronic device may be, for example, one associated with a provider's vehicle, such as one operated by the vehicle's driver. In this manner, a provider may schedule its drivers for facilitating on-demand liability transfers. In one example, the on-demand liability transfer scheduling order includes at least one selected date and one selected time for the liability transfer, such as ones selected by the customer.

In response to an on-demand liability transfer scheduling request, such as for a liability pickup, the provider may obtain (e.g., receive) an amount of liability from the customer at a pickup location. For example, the provider may obtain the amount of liability by driving to the customer location in a provider vehicle and obtaining the amount of liability from the customer. The amount of obtained liability may or may not be equal to an amount identified in the on-demand liability transfer scheduling request. For example, the on-demand liability transfer scheduling request may not identify an amount of the liability. As another example, the on-demand liability transfer scheduling request may identify an amount of liability, but the amount of obtained liability may be more than, or less than, the amount of liability identified in the on-demand liability transfer scheduling request. In one example, the on-demand liability transfer scheduling request may identify a certain amount of cash that is to be picked up by a provider. When the provider arrives at the customer location, the amount of cash picked up (e.g., obtained) may be more or less than the requested amount of cash due to business activities (e.g., selling, buying) that may have taken place between when the on-demand liability transfer scheduling request was placed and when the provider obtains the cash from the customer.

In one example, the electronic device associated with the provider receives, from another electronic device associated with the provider, a confirmation of a transfer of an amount of liability. For example, in the case of a liability pickup, such as a cash pickup, once a provider (e.g., a driver to a provider's vehicle) receives the liability from a customer, the provider may submit (e.g., enter in) the amount of the liability to a first electronic device, such as a tablet, where that electronic device transmits a confirmation of that liability transfer amount to a second electronic device. The second electronic device may be, for example, the above mentioned electronic device located at the provider's office. As such, the first electronic device confirms the liability transfer, and its amount, to the second electronic device.

In one example, an electronic device associated with the provider may verify a requested liability transfer amount with a received amount of liability to determine a third amount of liability. The third amount of liability may be an amount of liability that the customer, in the event of a liability pickup, is credited for (e.g., the provider acknowledges that the customer has transferred that amount of liability to the provider) or, in the case of a liability delivery, is debited for (e.g., the provider acknowledges that the customer has received that amount of liability from the provider, or the provider acknowledges having received that amount of liability from the customer via a B2B electronic payment). For example, a customer may request a liability transfer for a liability pickup for a certain amount, and the provider, during the liability pickup, may receive the same, or different, amount of liability. If the requested liability transfer amount is greater than the received liability transfer amount, the third amount of liability may be determined to be the received liability transfer amount. As such, the customer would be credited with an amount equivalent to the received liability transfer amount.

In one example, if the requested liability transfer amount equals the received amount of liability, the third amount of liability is determined to be equal to the received amount of liability. If the requested liability transfer amount is greater than the received amount of liability, the third amount of liability is determined to be equal to the received amount of liability. If the requested liability transfer amount is less than the received amount of liability, the third amount of liability is determined to be equal to the requested liability transfer amount.

In another example, such as one involving a liability pickup, the third amount of liability is the lesser of the requested liability transfer amount and the received amount of liability minus an additional amount. The additional amount may be a provider's fee for providing the service. In yet another example, such as one involving a liability delivery, the third amount of liability is determined to be the received amount of liability. The third amount of liability in this example may instead be determined to be the received amount of liability minus an additional amount. In one embodiment, the third amount of liability is a percentage of the lesser of the first amount of liability and the second amount of liability.

In one example, an electronic device associated with the provider may provide to another electronic device associated with the provider an indication of the verification of the requested liability transfer amount with the received amount of liability. For example, one electronic device associated with the provider (e.g., a device with a vehicle driver) may send a message, over one or more networks, to another electronic device associated with the provider (e.g., a device at provider's back office) that the verification completed in the amount of the third amount of liability. In one example, either of the electronic devices associated with the provider may provide to the electronic device associated with the customer an indication of this verification. For example, the indication may include whether the requested liability transfer amount is equal to the received amount of liability. The indication may also include the third amount of liability, in one embodiment.

In one example, if the requested liability transfer amount is not equal to the received amount of liability, an electronic device associated with the provider may transmit an indication of a verification error to the electronic device associated with the customer. Otherwise, if the requested liability transfer amount is equal to the received amount of liability, the electronic device associated with the provider may transmit an indication of a verification success to the electronic device associated with the customer. In one example, the electronic device associated with the provider transmits a verification success if the requested liability transfer amount is equal to the received amount of liability plus an additional amount. The additional amount may be, for example, a provider's fee charged to the customer.

In some embodiments, either an electronic device associated with the customer or an electronic device associated with the provider may initiate a B2B electronic payment. For example, to provide funds (e.g., pay) for a liability to be delivered by a provider to a customer, either the electronic device associated with the customer or the electronic device associated with the provider may initiate a B2B electronic payment from a bank account associated with the customer to a bank account associated with the provider for an amount of liability. For example, the customer may, via the electronic device associated with the customer, initiate a B2B electronic payment for a certain amount of funds from a bank account associated with the customer to a bank account associated with the provider when scheduling a liability delivery via an on-demand liability transfer scheduling request. In this manner, the customer may provide funds to the provider so that the provider may deliver liability to the customer, such as for the amount of the B2B electronic payment. In some examples, the B2B electronic payment may be initiated with, before, or after the transmission of an on-demand liability transfer scheduling request. The provider, in one example, may then deliver the amount of liability to the customer at a delivery location.

In another example, such as for a liability pickup (e.g., pickup of customer deposits), either the electronic device associated with the customer or the electronic device associated with the provider may initiate a B2B electronic payment from a bank account associated with the provider to a bank account associated with the customer for an amount of liability received. For example, to provide funds to a customer in return for picking up liability from the customer, a provider may, via an electronic device associated with the provider, initiate a B2B electronic payment from a bank account associated with the provider to a bank account associated with the customer for an amount of liability. The amount of the B2B electronic payment may be, for example, for the third amount of liability described above. As such, the provider funds a customer's bank account based on the amount of liability received from the customer. The B2B electronic payment may, in some examples, be initiated immediately after, or soon thereafter, of receiving an on-demand liability transfer scheduling request for a liability pickup.

In one example, the funds associated with a liability pickup may be used by a customer to fund a liability delivery. For example, the customer may schedule, via an on-demand liability transfer scheduling request, both a liability delivery and a liability pickup. Rather than initiating a B2B electronic payment from a customer bank account to a provider bank account for the value of the liability delivery, a B2B electronic payment may be initiated from a customer bank account to a provider bank account for the difference between the value of the liability delivery and the liability pickup (assuming the value of the liability delivery is more than the value of the liability pickup). In one example, if the value of the liability delivery and the liability pickup are the same, then no B2B electronic payment is initiated. In another example, a B2B electronic payment is initiated from a customer bank account to a provider bank account to cover the cost of a provider fee.

Among other advantages, the apparatus and methods allow for the on-demand (e.g., as needed) scheduling of liability transfers such as liability pickups and liability deliveries. The apparatus and methods may also reduce delay between when a customer schedules an on-demand liability pickup and when funds are credited to the customer's bank account. For example, by initiating a B2B electronic payment from a provider's bank account to a customer's bank account soon thereafter of the provider having received the liability from the customer (e.g., in the parking lot at a customer's location after having received the liability from the customer), the apparatus and methods allow for the customer to receive funds rapidly. Similarly, the apparatus and methods provide for a reduced delay between when a customer schedules an on-demand liability delivery and when the liability is delivered to the customer. For example, by initiating a B2B electronic payment from a customer's bank account to a provider's bank account along with, or soon thereafter of, scheduling a liability delivery, the apparatus and methods allow a provider to receive funds more rapidly.

Moreover, the apparatus and methods may reduce the handling of liability by others, such as processing clerks, thus reducing monetary risk in terms of, for example, miscalculating amounts of liability, losing consolidated bags, and the loss of liability. Other benefits may include the reduction or elimination of costs paid by a customer to an armored carrier service, reduction of customer funds at third party bank vaults, and the reduction of overhead work undertaken by a customer, among other advantages as recognized by those of ordinary skill in the art.

### BRIEF DESCRIPTION OF THE DRAWINGS

The disclosure will be more readily understood in view of the following description when accompanied by the below figures and wherein like reference numerals represent like elements, wherein:

FIG. 1 is a block diagram generally illustrating one example of an on-demand scheduling system employing an electronic device associated with a customer with on-demand liability transfer scheduling request logic and a plurality of electronic devices associated with a provider with on-demand liability transfer scheduling order logic in accordance with one example set forth in the disclosure;

FIG. 2 is a block diagram illustrating a more detailed view of the customer device with on-demand liability transfer scheduling request logic of FIG. 1 in accordance with one example set forth in the disclosure;

FIG. 3 is a block diagram illustrating a more detailed view of the provider device with on-demand liability transfer scheduling order logic of FIG. 1 in accordance with one example set forth in the disclosure;

FIG. 4 is a flowchart illustrating one example of a method by an electronic device associated with a provider in accordance with one example set forth in the disclosure;

FIG. 5 is a flowchart illustrating another example of a method by an electronic device associated with a provider in accordance with one example set forth in the disclosure;

FIG. 6 is a flowchart illustrating an example of a method by an electronic device associated with a provider and an electronic device associated with a customer in accordance with one example set forth in the disclosure;

FIG. 7 is a diagram of an example system including an electronic device associated with a provider with on-demand liability transfer scheduling order logic, an input/output (I/O) device, a display device, and provider device logic code residing in memory in accordance with one example set forth in the disclosure; and

FIG. 8 is a diagram of an example system including an electronic device associated with a customer with on-demand liability transfer scheduling request logic, an I/O device, a display device, and customer device logic code residing in memory in accordance with one example set forth in the disclosure.

### DETAILED DESCRIPTION OF EMBODIMENTS

Exemplary embodiments provide technical solutions that address one or more of the problems discussed above. For example, the exemplary embodiments may provide technical solutions that address the problems of delay between when a customer schedules an on-demand liability pickup and when funds are credited to the customer's bank account. As another example, the exemplary embodiments may provide technical solutions that address the problems of delay between when a customer schedules an on-demand liability delivery and when the liability is delivered to the customer.

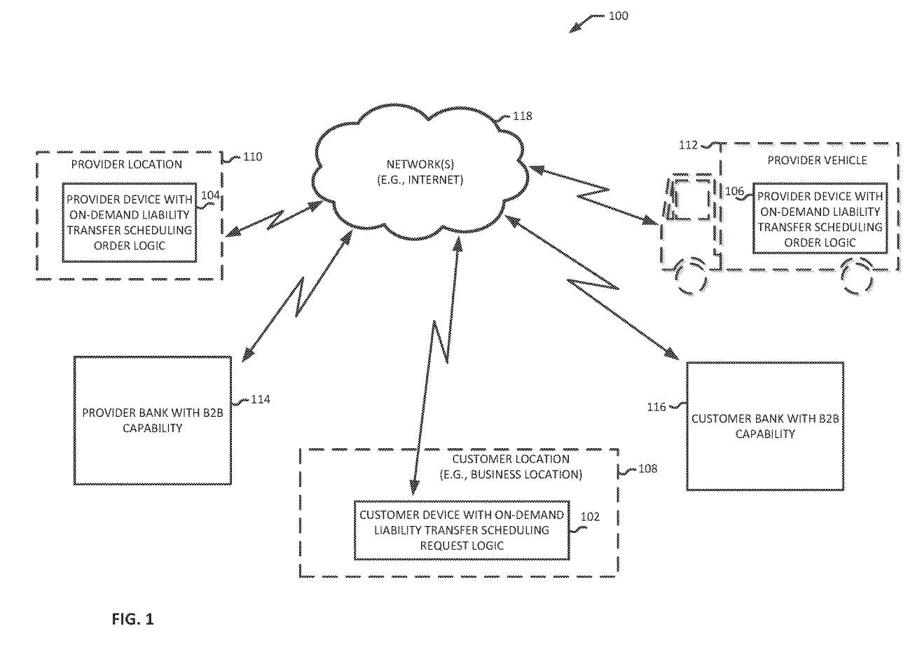

Turning to the drawings, FIG. 1 is a diagram illustrating one example of an on-demand scheduling system 100 that includes a customer device (i.e., electronic device associated with a customer) with on-demand liability transfer scheduling request logic 102, provider device (i.e., electronic device associated with a provider) with on-demand liability transfer scheduling order logic 104, and provider device with on-demand liability transfer scheduling order logic 106. Each of the customer device 102 and provider devices 104, 106 may be a workstation, computer, an electronic mobile device, a wireless mobile device, a cell phone, a tablet, a laptop, portable media device, in-vehicle display system, an ATM machine, a parking meter, a gaming device such as a video gaming terminal, a redemption terminal, any electronic machine that dispenses or receives money, or any other suitable electronic device. As indicated in the figure, customer device 102 may be located at a customer location 108. Customer location 108 may be any customer location, such as a customer office location. Similarly, provider device 104 may be located at a provider location 110, such as a provider's office (e.g., back office), and provider device 106 may be located remotely such as in provider vehicle 112. In one example, one or more provider vehicles 112 service a particular geographic area.

Each of customer device 102, provider device 104, and provider device 106 are operable to connect to one or more networks 118. One or more networks 118 may be any suitable networks, such as networks that provide an Internet connection, or any other suitable network allowing for communication between devices. Networks that allow Internet connections may include wireless wide area networks (WWAN) such as cellular networks that communicate using radio access technologies (RATs such as Global System for Mobiles (GSM), Code Division Multiple Access (CDMA), 4G LTE or other radio access technologies) as well as wireless local area networks (WLAN) including Wi-Fi networks. As such, each of customer device 102, provider device 104, and provider device 106 are operable to communicate with each other over the one or more networks 118.

FIG. 1 also includes a provider bank with B2B capability 114, and a customer bank with B2B capability 116, each of which is operable to connect to one or more networks 118. As such, each of customer device 102, provider device 104, and provider device 106 are operable to communicate with provider bank with B2B capability 114 and customer bank with B2B capability 116 over one or more networks 118. For example, customer device 102 may be operable to initiate a B2B electronic payment from a bank account associated with the customer at customer bank with B2B capability 116 to a bank account associated with the provider at provider bank with B2B capability 114. Similarly, provider device 104 and provider device 106 may each be operable to initiate a B2B electronic payment from a bank account associated with the customer at customer bank with B2B capability 116 to a bank account associated with the provider at provider bank with B2B capability 114. Likewise, provider device 104 and provider device 106 may each be operable to initiate a B2B electronic payment from a bank account associated with the provider at provider bank with B2B capability 114 to a bank account associated with the customer at customer bank with B2B capability 116.

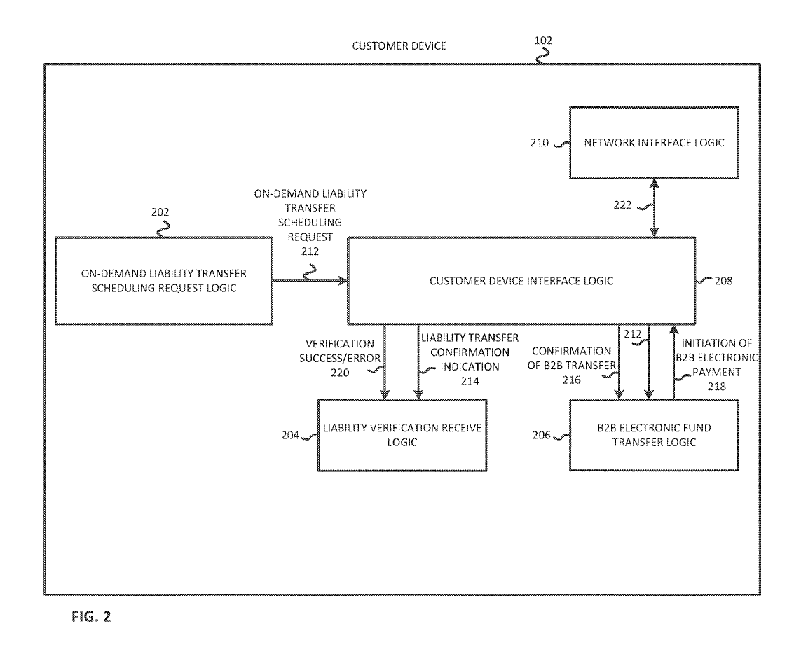

FIG. 2 is a block diagram providing more details of the customer device 102 of FIG. 1. As indicated in the figure, customer device 102 includes on-demand liability transfer scheduling request logic 202, liability verification receive logic 204, B2B electronic fund transfer logic 206, and network interface logic 210 operatively coupled to one another via customer device interface logic 208. On-demand liability transfer scheduling request logic 202 is operable to generate an on-demand liability transfer scheduling request 212 and provide it to customer device interface logic 208. The on-demand liability transfer scheduling request 212 may be generated by on-demand liability transfer scheduling request logic 202 based on user provided input, such as input received via an input/output (I/O) device (e.g., keyboard, stylus) (not shown). On-demand liability transfer scheduling request 212 may include, for example, a request for a liability transfer, such as one or more of a liability pickup and a liability delivery. The on-demand liability transfer scheduling request 212 may be associated with (e.g., include) a requested time and a requested location for the liability transfer. The on-demand liability transfer scheduling request 212 may also be associated with an amount of liability.

Liability verification receive logic 204 may be operable to obtain, from customer device interface logic 208, a verification success or verification error indication (e.g., message) 214, or a liability transfer confirmation indication 220. For example, a verification success or verification error indication 214, or a liability transfer confirmation 220, may be received by customer device 102 from either provider device 104 or provider device 106 of FIG. 1. Liability verification receive logic 204 may be operable to provide for display the received indications. Liability verification receive logic 204 may be also be operable to store the received indications in memory.

B2B electronic fund transfer logic 206 is operable to initiate a B2B electronic payment 218 from one bank account to another. For example, B2B electronic fund transfer logic 206 may be operable to initiate a B2B electronic payment 218 from a bank account associated with the customer, such as from one at the customer bank with B2B capability 116 of FIG. 1, to a bank account associated with the provider, such as to one at the provider bank with B2B capability 114 of FIG. 1. B2B electronic fund transfer logic 206 may initiate a B2B electronic payment 218 based on user provided input (not shown). Alternatively, B2B electronic fund transfer logic 206 may initiate a B2B electronic payment 218 based on the transmission of an on-demand liability transfer scheduling request 212. For example, B2B electronic fund transfer logic 206 may receive the on-demand liability transfer scheduling request 212 and, in response, initiate a B2B electronic payment 218 from a bank account associated with the customer to a bank account associated with the provider that corresponds to the on-demand liability transfer scheduling request 212. B2B electronic fund transfer logic 206 may also be operable to receive a confirmation of a B2B electronic payment 216, such as one from either provider device 104 or provider device 106 of FIG. 1.

Customer device interface logic 208 is operable to format data for transmission and provide it to network interface logic 210 over bus 222. Network interface logic 210 may then transmit the data over one or more networks, such as the one or more networks 118 of FIG. 1. For example, customer device interface logic 208 is operable to format for transmission on-demand liability transfer scheduling request 212 to, for example, a provider device such as provider device 104 of FIG. 1. Similarly, customer device interface logic 208 may be operable to format for transmission the initiation of B2B electronic payment 218 to, for example, a bank such as the customer bank with B2B capability 116 of FIG. 1.

Network interface logic 210 may also be operable to receive transmissions and provide the received transmissions over bus 222 to customer device interface logic 208. For example, network interface logic 210 may receive data corresponding to a verification success or verification error indication and provide the data to customer device interface logic 208, which may format the data and provide the verification success or verification error 214 to liability verification receive logic 204. Similarly, network interface logic 210 may receive data corresponding to a confirmation of a B2B electronic payment and provide the data to customer device interface logic 208, which may format the data to provide the confirmation of the B2B electronic payment 216 to B2B electronic fund transfer logic 206.

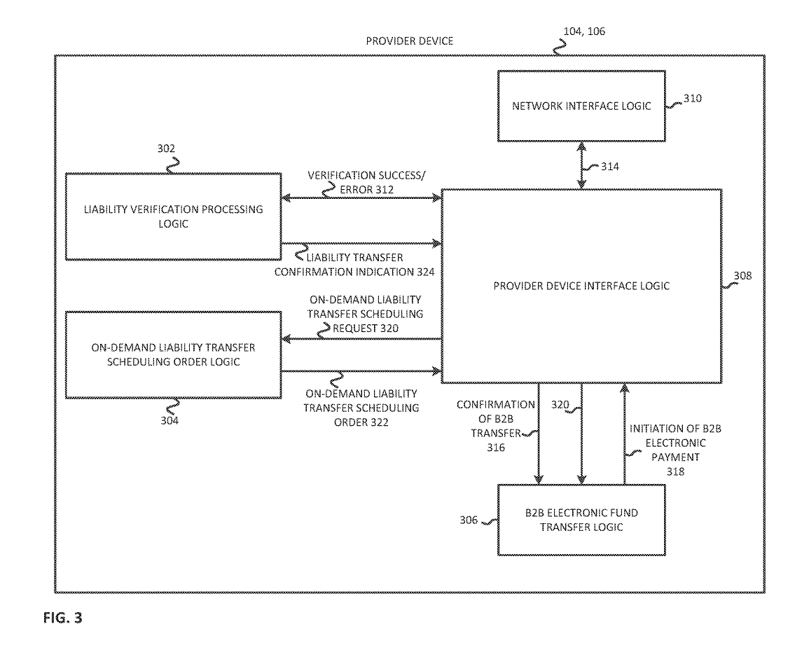

FIG. 3 is a block diagram providing more details of the provider devices 104, 106 of FIG. 1. As indicated in the figure, processor devices 104, 106 include liability verification processing logic 302, on-demand liability transfer scheduling order logic 304, B2B electronic fund transfer logic 306, and network interface logic 310 operatively coupled to one another via provider device interface logic 308. On-demand liability transfer scheduling order logic 304 is operable to generate an on-demand liability transfer scheduling order 322 and provide it to provider device interface logic 308. The on-demand liability transfer scheduling order 322 may be transmitted to another provider device, such as provider devices 104, 106, to schedule a liability transfer with a customer. For example, provider device 104 of FIG. 1 may generate an on-demand liability transfer scheduling order 322 to transmit to provider device 106 of FIG. 1 to schedule a vehicle driver for a liability transfer at a customer location.

The on-demand liability transfer scheduling order 322 may be generated by on-demand liability transfer scheduling order logic 304 based on a received on-demand liability transfer scheduling request 320, which may be received from a customer device, such as the customer device 102 of FIGS. 1 and 2. On-demand liability transfer scheduling order logic 304 may be operable to verify provider availability for a liability transfer at a requested time and a requested location to determine a scheduled time and scheduled location for the liability transfer. For example, upon receiving an on-demand liability transfer scheduling request 320, on-demand liability transfer scheduling order logic 304 may generate an on-demand liability transfer scheduling order 322 based on the availability of the provider. In one example, on-demand liability transfer scheduling order logic 304 generates an on-demand liability transfer scheduling order 322 for transmission to a particular provider device 106 based on various metrics such as, for example, current location of provider vehicles (obtainable via, for example, GPS), expected location of provider vehicles, vehicle operation hours, and possibly others.

Liability verification processing logic 302 may be operable to verify a first amount of liability (e.g., a requested liability transfer amount) with a second amount of liability (e.g., a received amount of liability) to determine a third amount of liability. Liability verification processing logic 302 may also be operable to generate a verification success or verification error indication 312 to transmit to, for example, the customer device 116 of FIG. 1. For example, the verification success or verification error indication 312 may be based on the determined third amount of liability.

Liability verification processing logic 302 may also be operable to generate a liability transfer confirmation indication 324 to be transmitted to, for example, the customer device 116 of FIG. 1. For example, upon obtaining an amount of liability from a customer, a provider may submit the amount of liability obtained to provider device 106, whereby liability verification processing logic 302 transmits a confirmation of the liability transfer amount transferred to another electronic device. In one example, liability verification processing logic 302 is operatively coupled to a cash counting machine, and electronically obtains an amount of liability received from a customer from the cash counting machine. Cash counting machines may include, for example, cash recyclers, currency counters, two pocket machines, and nine pocket machines. Liability verification processing logic 302 may be operable to provide for display verification success, verification error, and liability transfer confirmation indications. Liability verification receive processing logic 302 may be also be operable to store the indications in memory. In one example, verification success, verification error, and liability transfer confirmation indications are provided for display via a portal, such as a web-based portal.

B2B electronic fund transfer logic 306 is similar to the B2B electronic fund transfer logic 206 of FIG. 2 and is operable to initiate a B2B electronic payment 318 from one bank account to another. For example, B2B electronic fund transfer logic 306 may be operable to initiate a B2B electronic payment 318 from a bank account associated with the customer, such as from one at the customer bank with B2B capability 116 of FIG. 1, to a bank account associated with the provider, such as to one at the provider bank with B2B capability 114 of FIG. 1. As another example, B2B electronic fund transfer logic 306 may be operable to initiate a B2B electronic payment 318 from a bank account associated with the provider, such as from one at the provider bank with B2B capability 114 of FIG. 1, to a bank account associated with the customer, such as to one at the customer bank with B2B capability 116 of FIG. 1. B2B electronic fund transfer logic 306 may initiate a B2B electronic payment 318 based on user provided input (not shown). Alternatively, B2B electronic fund transfer logic 306 may initiate a B2B electronic payment 318 based on the provider device 104, 106 receiving an on-demand liability transfer scheduling request 320. For example, B2B electronic fund transfer logic 306 may receive an on-demand liability transfer scheduling request 320 and, in response, initiate a B2B electronic payment 318 from a bank account associated with the customer to a bank account associated with the provider. B2B electronic fund transfer logic 306 may also be operable to receive a confirmation of a B2B electronic payment 316, such as one from another provider device 104, 106.

Provider device interface logic 308 is operable to format data for transmission and provide it to network interface logic 310 over bus 314. Network interface logic 310 may be operable to transmit the data over one or more networks, such as the one or more networks 118 of FIG. 1. For example, provider device interface logic 310 is operable to format for transmission on-demand liability transfer scheduling order 322 to, for example, a provider device such as a provider device 106. Similarly, provider device interface logic 308 may be operable to format for transmission the initiation of B2B electronic payment 318 to, for example, a bank such as the customer bank with B2B capability 116 of FIG. 1.

Network interface logic 310 may also be operable to receive transmissions and provide the received transmissions over bus 314 to provider device interface logic 308. For example, network interface logic 310 may receive data corresponding to an on-demand liability transfer scheduling request and provide the data to provider device interface logic 208, which may format the data and provide the on-demand liability transfer scheduling request 320 to on-demand liability transfer scheduling order logic 304. Similarly, network interface logic 310 may receive data corresponding to a confirmation of a B2B electronic payment and provide the data to provider device interface logic 308, which may format the data to provide the confirmation of the B2B electronic payment 316 to B2B electronic fund transfer logic 306.

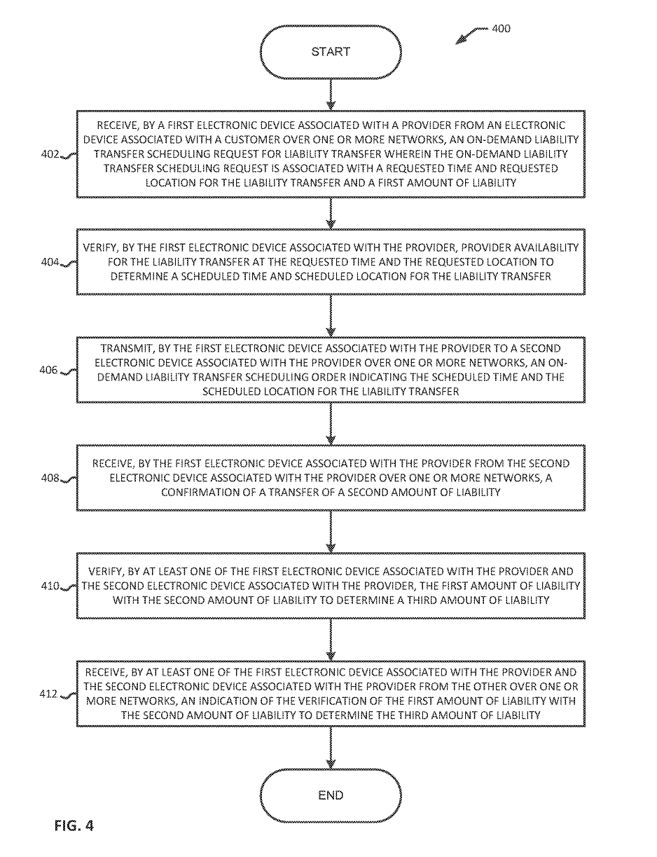

Referring to FIG. 4, a method 400 of operation of an electronic device associated with a provider, such as provider device 104 or provider device 106, will be described. Parts or all of this method, and parts or all of the methods described herein, may define an algorithm that may be implemented by one or more processors executing suitable instructions. At block 402, a first electronic device associated with a provider receives from a customer device, such as customer device 102 of FIG. 1, an on-demand liability transfer scheduling request for a liability transfer. The liability transfer may include one or more of a liability pickup, or a liability delivery. The on-demand liability transfer scheduling request is associated with a requested time and a requested location for the liability transfer. The on-demand liability transfer scheduling request may also be associated with a first amount of liability. At block 404, the first electronic device associated with the provider verifies provider availability for the liability transfer at the requested time and the requested location to determine a scheduled time and scheduled location for the liability transfer. For example, the scheduled time may be the same as the requested time, or the scheduled time may be a different time than the requested time, based on provider availability. At block 406, the first electronic device associated with the provider transmits, to a second electronic device associated with the provider over one or more networks, on-demand liability transfer scheduling order that indicates the scheduled time and the scheduled location for the liability transfer.

Proceeding to block 408, the first electronic device associated with the provider receives, from the second electronic device associated with the provider over one or more networks, a confirmation of a transfer of a second amount of liability. At block 410, at least one of the first electronic device associated with the provider and the second electronic device associated with the provider verifies the first amount of liability with the second amount of liability to determine a third amount of liability. Finally, at block 412, at least one of the first electronic device associated with the provider and the second electronic device associated with the provider receives, from the other over one or more networks, an indication of the verification of the first amount of liability with the second amount of liability to determine the third amount of liability.

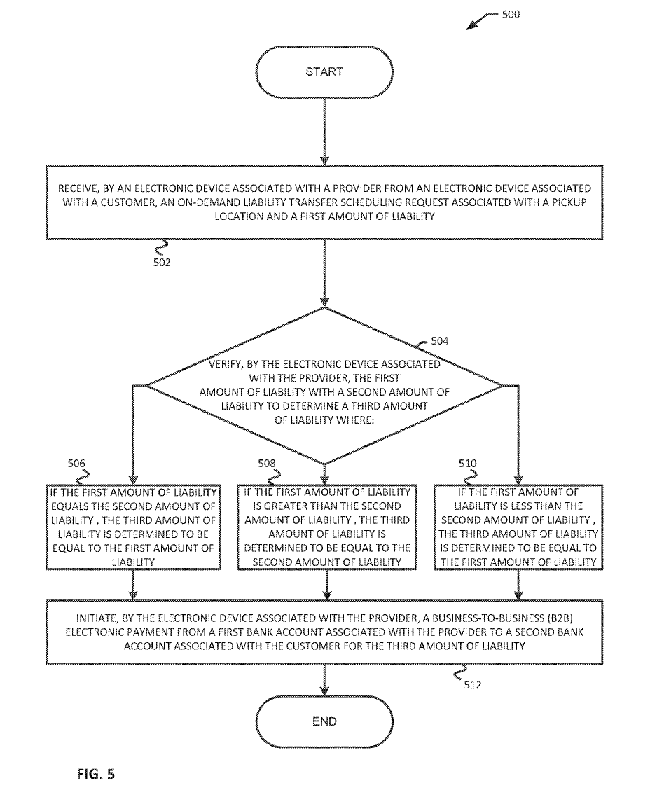

FIG. 5 illustrates a method 500 of operation of an electronic device associated with a provider, such as provider device 104 or provider device 106 of FIG. 1. The method begins at block 502, where an electronic device associated with a provider receives, from an electronic device associated with a customer, such as customer device 102 of FIG. 1, an on-demand liability transfer scheduling request associated with a pickup location and a first amount of liability. At decision block 504, the electronic device associated with the provider verifies the first amount of liability with a second amount of liability (e.g., the second amount of liability may be an amount of liability obtained from the customer) to determine a third amount of liability. At block 506, if the first amount of liability is equal to the second amount of liability, the third amount of liability is determined to be equal to the first amount of liability. If the first amount of liability is greater than the second amount of liability, at block 508 the third amount of liability is determined to be equal to the second amount of liability. Otherwise, if the first amount of liability is less than the second amount of liability, at block 510 the third amount of liability is determined to be equal to the first amount of liability. At block 512, the electronic device associated with a provider initiates a B2B electronic payment from a first bank account associated with the provider to a second bank account associated with the customer for the third amount of liability. In one example, the B2B electronic payment is initiated immediately after the third amount of liability has been verified.

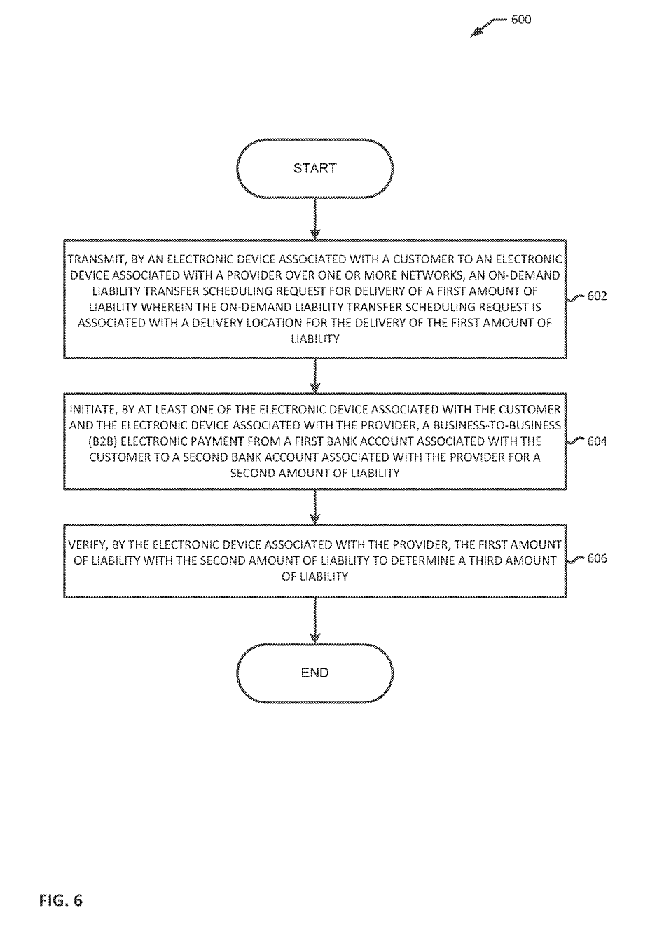

FIG. 6 illustrates a method 600 by an electronic device associated with a provider, such as provider device 104 or provider device 106 of FIG. 1, and an electronic device associated with a customer, such as customer device 102. The method begins at block 602, where the electronic device associated with the customer transmits, to the electronic device associated with the provider, an on-demand liability transfer scheduling request for delivery of a first amount of liability. The on-demand liability transfer scheduling request is associated with a delivery location for the delivery of the first amount of liability. At block 604, at least one of the electronic device associated with a customer and the electronic device associated with a provider initiate a B2B electronic payment from a first bank account associated with the customer to a second bank account associated with the provider for a second amount of liability. In one example, the B2B electronic payment is initiated along with, or immediately after, the on-demand liability transfer scheduling request is transmitted. At block 606, the electronic device associated with the provider verifies the first amount of liability with the second amount of liability to determine a third amount of liability. In one example, the provider may then deliver to the customer the third amount of liability at the delivery location.

In some embodiments, some or all of the functions (e.g., actions) of customer device 102 and processor device 104, 106 may be performed by one or more suitable processors executing suitable instructions, such as a Central Processing Unit (CPU), Digital Signal Processors (DSPs), microprocessors, or any other suitable processor, or by any other suitable logic, such as discreet logic, Field Programmable Gate Arrays (FPGAs), or Application Specific Integrated Circuits (ASICs). In some examples, the executable suitable instructions may be stored on a computer readable storage medium, where the executable instructions are executable by one or more processors to cause the one or more processors to perform some or all of the functions described herein, such as the functions of customer device 102 and provider device 104, 106.

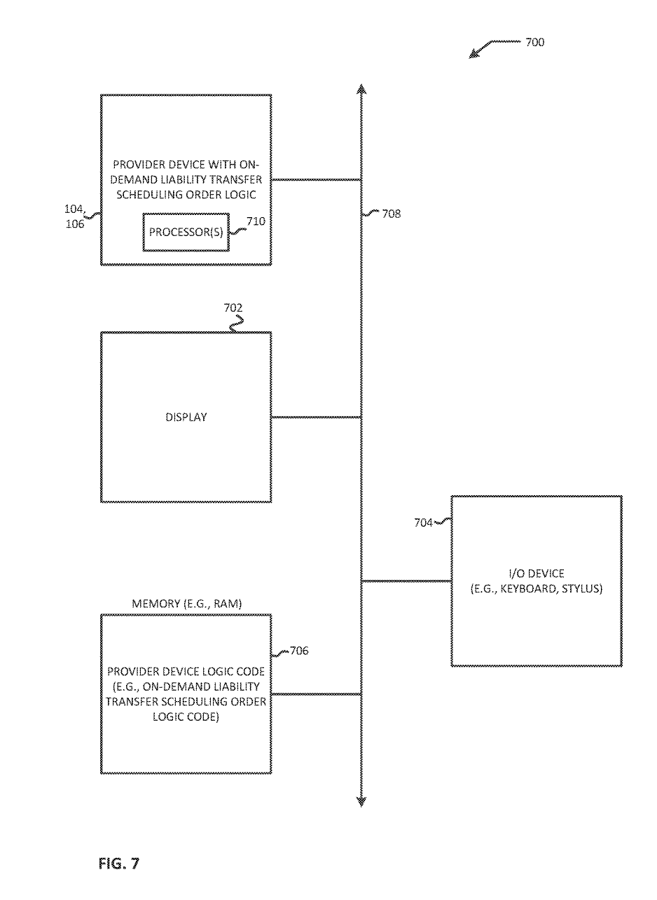

Referring to FIG. 7, a diagram of an example system 700 is shown that includes an electronic device associated with a provider device with on-demand liability transfer scheduling order logic 104, 106 from FIG. 1, a display device 702, an input/output (I/O) device 704, and provider device logic code residing in memory 706, all operatively connected to expansion bus 708. In this example, provider device with on-demand liability transfer scheduling order logic 104, 106 includes one or more processors 710. Expansion bus 708 may be, for example, any number of interconnects allowing communications among the various devices, or any other suitable bus. In one example, expansion bus 708 may be a wireless network allowing communications between wireless devices. Memory 706 is illustrated as storing provider device logic code and may be any suitable computer readable storage medium. Examples of computer readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). As such, provider device with on-demand liability transfer scheduling order logic 104, 106 may include one or more processors and is operable to obtain provider device logic code from memory 706 over expansion bus 708 for execution by the one or more processors 710.

Provider device with on-demand liability transfer scheduling order logic 104, 106 may receive user input via I/O device 704. For example, a user may submit input via I/O device 704 to have provider device with on-demand liability transfer scheduling order logic 104, 106 generate an on-demand liability transfer scheduling order. Provider device with on-demand liability transfer scheduling order logic 104, 106 may provide images for display to display device 702. For example, provider device with on-demand liability transfer scheduling order logic 104, 106 may provide for display images indicating a verification success or verification error, or a confirmation of a B2B electronic payment.

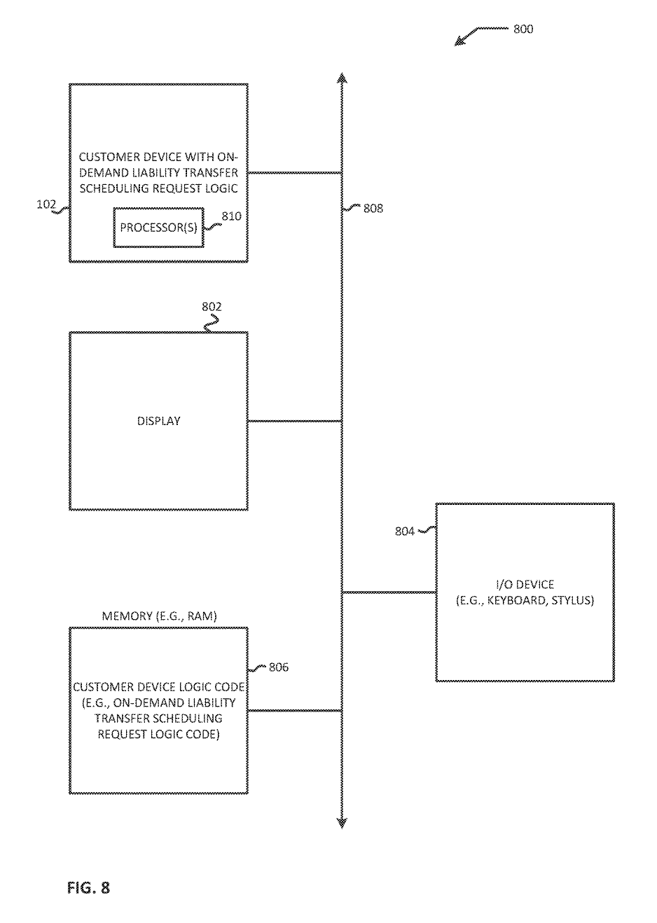

FIG. 8 illustrates a diagram of an example system 800 that includes an electronic device associated with a customer device with on-demand liability transfer scheduling request logic 102 from FIG. 1, a display device 802, an input/output (I/O) device 804, and customer device logic code residing in memory 806, all operatively connected to expansion bus 808. In this example, customer device with on-demand liability transfer scheduling order logic 104, 106 includes one or more processors 810. Expansion bus 808 may be, for example, any number of interconnects allowing communications among the various devices, or any other suitable bus. In one example, expansion bus 808 may be a wireless network allowing communications between wireless devices. Memory 806 is illustrated as storing customer device logic code, and may be any suitable computer readable storage medium. As such, customer device with on-demand liability transfer scheduling order logic 102 may include one or more processors and is operable to obtain customer device logic code from memory 806 over expansion bus 808 for execution by the one or more processors 810.

Customer device with on-demand liability transfer scheduling order logic 104, 106 may receive user input via I/O device 804. For example, a user may submit input via I/O device 704 to have customer device with on-demand liability transfer scheduling order logic 102 generate an on-demand liability transfer scheduling request. Customer device with on-demand liability transfer scheduling order logic 102 may provide images for display to display device 802. For example, customer device with on-demand liability transfer scheduling order logic 102 may provide for display images indicating a verification success or verification error, or a confirmation of a B2B electronic payment.

Among other advantages, the apparatus and methods allow for the on-demand scheduling of liability transfers such as liability pickups and liability deliveries. The apparatus and methods may also reduce delay between when a customer schedules an on-demand liability pickup and when funds are credited to the customer's bank account. For example, by initiating a B2B electronic payment from a provider's bank account to a customer's bank account soon thereafter of the provider having received the liability from the customer, the apparatus and methods allow for the customer to receive funds rapidly. Similarly, the apparatus and methods provide for a reduced delay between when a customer schedules an on-demand liability delivery and when the liability is delivered to the customer. For example, by initiating a B2B electronic payment from a customer's bank account to a provider's bank account along with, or soon thereafter of, scheduling a liability delivery, the apparatus and methods allow a provider to receive funds more rapidly. Moreover, the apparatus and methods may reduce the handling of liability by others, such as processing clerks, thus reducing monetary risk in terms of, for example, miscalculating amounts of liability, losing consolidated bags, and the loss of liability. Other benefits may include the reduction or elimination of costs paid by a customer to an armored carrier service, reduction of customer funds at third party bank vaults, and the reduction of overhead work undertaken by a customer, among other advantages as recognized by those of ordinary skill in the art.

The above detailed description and the examples described therein have been presented for the purposes of illustration and description only and not for limitation. For example, the operations described may be done in any suitable manner. Although features and elements are described above in particular combinations, each feature or element can be used alone, without the other features and elements, or in various combinations with or without other features and elements. Moreover, the methods may be done in any suitable order while still providing the described operations and results. It is therefore contemplated that the present embodiments cover any and all modifications, variations, or equivalents that fall within the spirit and scope of the basic underlying principles disclosed above and claimed herein. Furthermore, while examples in the above description describe hardware in the form of a processor executing code, hardware in the form of a state machine, or dedicated logic capable of producing the same effect, are also contemplated.

What is claimed is:

1. A method by one or more electronic devices for an on-demand scheduling service for a liability transfer comprising:
receiving, by a first electronic device associated with a provider from an electronic device associated with a customer over one or more networks, an on-demand liability transfer scheduling request for the liability transfer wherein the on-demand liability transfer scheduling request is associated with a requested time and a requested location for the liability transfer and a first amount of liability;
verifying, by the first electronic device associated with the provider, provider availability for the liability transfer at the requested time and the requested location to determine a scheduled time and scheduled location for the liability transfer;
transmitting, by the first electronic device associated with the provider to a second electronic device associated with the provider over one or more networks, an on-demand liability transfer scheduling order indicating the scheduled time and the scheduled location for the liability transfer;
receiving, by the first electronic device associated with the provider from the second electronic device associated with the provider over one or more networks, a confirmation of a transfer of a second amount of liability;
verifying, by at least one of the first electronic device associated with the provider and the second electronic device associated with the provider, the first amount of liability with the second amount of liability to determine a third amount of liability; and
receiving, by at least one of the first electronic device associated with the provider and the second electronic device associated with the provider from the other, an indication of the verification of the first amount of liability with the second amount of liability to determine the third amount of liability.

2. The method of claim 1 wherein verifying, by the first electronic device associated with the provider, provider availability for the liability transfer at the time and the location comprises:
transmitting, by the first electronic device associated with the provider to the electronic device associated with the customer, a plurality of available times for the liability transfer based on the requested time and the requested location for the liability transfer;
receiving, by the first electronic device associated with the provider from the electronic device associated with the customer, a selection of at least one selected date and at least one selected time for the liability transfer based on the plurality of available times; and
transmitting, by the first electronic device associated with the provider to the electronic device associated with the customer, the scheduled time and the scheduled location for the liability transfer based on the received selection of the at least one selected date and one selected time.

3. The method of claim 2 wherein the requested time for the liability transfer is a future time, wherein the plurality of available times for the liability transfer comprise at least one future date, wherein the selection of the at least one selected date for the liability transfer comprises the at least one future date.

4. The method of claim 1 wherein verifying, by the at least one of the first electronic device associated with the provider and the second electronic device associated with the provider, the first amount of liability with the second amount of liability to determine the third amount of liability comprises determining, by the at least one of the first electronic device associated with the provider and the second electronic device associated with the provider, the third amount of liability based on whether the first amount of liability equals the second amount of liability wherein:
if the first amount of liability equals the second amount of liability, the third amount of liability is determined to be equal to the first amount of liability;
if the first amount of liability is greater than the second amount of liability, the third amount of liability is determined to be equal to the second amount of liability; and
if the first amount of liability is less than the second amount of liability, the third amount of liability is determined to be equal to the first amount of liability.

5. The method of claim 4 wherein:
if the first amount of liability is not equal to the second amount of liability, transmitting, by at least one of the first electronic device associated with the provider and the second electronic device associated with the provider, an indication of a verification error to the electronic device associated with the customer; and
if the first amount of liability is equal to the second amount of liability, transmitting, by the electronic device associated with the provider, an indication of a verification success to the electronic device associated with the customer.

6. The method of claim 1 comprising determining, by at least one of the first electronic device associated with the provider and the second electronic device associated with the provider, that the third amount of liability is the lesser of the first amount of liability and the second amount of liability minus an additional amount.

7. A method for a liability pickup from a customer by a provider comprising:
receiving, by an electronic device associated with the provider from an electronic device associated with a customer over one or more networks, an on-demand liability transfer scheduling request for a liability pickup wherein the on-demand liability transfer scheduling request is associated with a pickup location and a first amount of liability;
obtaining, by the provider and in response to the on-demand liability transfer scheduling request, a second amount of liability from the customer at the pickup location;
verifying, by the electronic device associated with the provider, the first amount of liability with the second amount of liability to determine a third amount of liability; and
initiating, by the electronic device associated with the provider, a business-to-business (B2B) electronic payment from a first bank account associated with the provider to a second bank account associated with the customer for the third amount of liability.

8. The method of claim 7 wherein verifying, by the electronic device associated with the provider, the first amount of liability with the second amount of liability to determine the third amount of liability comprises determining whether the first amount of liability equals the second amount of liability wherein:
if the first amount of liability equals the second amount of liability, the third amount of liability is determined to be equal to the first amount of liability;
if the first amount of liability is greater than the second amount of liability, the third amount of liability is determined to be equal to the second amount of liability; and
if the first amount of liability is less than the second amount of liability, the third amount of liability is determined to be equal to the first amount of liability.

9. The method of claim 7 wherein verifying, by the electronic device associated with the provider, the first amount of liability with the second amount of liability to determine the third amount of liability comprises determining that the third amount of liability is the lesser of the first amount of liability and the second amount of liability minus an additional amount.

10. The method of claim 7 wherein verifying, by the electronic device associated with the provider, the first amount of liability with the second amount of liability to determine the third amount of liability comprises determining whether the first amount of liability is equal to the second amount of liability wherein:
if the first amount of liability is not equal to the second amount of liability, transmitting, by the electronic device associated with the provider, an indication of a verification error to the electronic device associated with the customer; and
if the first amount of liability is equal to the second amount of liability, transmitting, by the electronic device associated with the provider, an indication of a verification success to the electronic device associated with the customer.

11. The method of claim 7 further comprising transmitting, by the electronic device associated with the provider to the electronic device associated with the customer, an indication of the B2B electronic payment.

12. A method for a liability delivery to a customer by a provider comprising:
transmitting, by an electronic device associated with the customer to an electronic device associated with the provider over one or more networks, an on-demand liability transfer scheduling request for delivery of a first amount of liability wherein the on-demand liability transfer scheduling request is associated with a delivery location for the delivery of the first amount of liability;
initiating, by at least one of the electronic device associated with the customer and the electronic device associated with the provider, a business-to-business (B2B) electronic payment from a first bank account associated with the customer to a second bank account associated with the provider for a second amount of liability;
verifying, by the electronic device associated with the provider, the first amount of liability with the second amount of liability to determine a third amount of liability; and
delivering, by the provider to the customer, the third amount of liability at the delivery location.

13. The method of claim 12 wherein verifying, by the electronic device associated with the provider, the first amount of liability with the second amount of liability to determine the third amount of liability comprises determining that the third amount of liability is equal to the second amount of liability.

14. The method of claim 12 wherein verifying, by the electronic device associated with the provider, the first amount of liability with the second amount of liability to determine the third amount of liability comprises determining that the third amount of liability is the second amount of liability minus an additional amount.

15. The method of claim 12 wherein verifying, by the electronic device associated with the provider, the first amount of liability with the second amount of liability to determine the third amount of liability comprises determining whether the first amount of liability is equal to the second amount of liability wherein:
if the first amount of liability is not equal to the second amount of liability, transmitting, by the electronic device associated with the provider, an indication of a verification error to the electronic device associated with the customer; and
if the first amount of liability is equal to the second amount of liability, transmitting, by the electronic device associated with the provider, an indication of a verification success to the electronic device associated with the customer.

16. The method of claim 12 further comprising transmitting, by the at least one of the electronic device associated with the customer and the electronic device associated with the provider to another of the at least one of the electronic device associated with the customer and the electronic device associated with the provider, an indication of the B2B electronic payment.

17. The method of claim 12 comprising transmitting, by the electronic device associated with the provider to the electronic device associated with the customer, an indication of the third amount of liability.

18. A first electronic device associated with a provider for an on-demand scheduling service for a liability transfer operable to:
receive, from an electronic device associated with the customer over one or more networks, an on-demand liability transfer scheduling request for the liability transfer wherein the on-demand liability transfer scheduling request is associated with a requested time and a requested location for the liability transfer and a first amount of liability;
verify provider availability for the liability transfer at the requested time and the requested location to determine a scheduled time and scheduled location for the liability transfer;
transmit, to a second electronic device associated with the provider over one or more networks, an on-demand liability transfer scheduling order indicating the scheduled time and the scheduled location for the liability transfer;
receive, from the second electronic device associated with the provider over one or more networks, a confirmation of a transfer of a second amount of liability;
verify the first amount of liability with the second amount of liability to determine a third amount of liability; and
receive, from the second electronic device associated with the provider, an indication of the verification of the first amount of liability with the second amount of liability to determine the third amount of liability.

19. The first electronic device of claim 18 further operable to:
transmit, to the electronic device associated with the customer, a plurality of available times for the liability transfer based on the requested time and the requested location for the liability transfer;
receive, from the electronic device associated with the customer, a selection of at least one selected date and at least one selected time for the liability transfer based on the plurality of available times; and
transmit, to the electronic device associated with the customer, the scheduled time and the scheduled location for the liability transfer based on the received selection of the at least one selected date and one selected time.

20. The first electronic device of claim 19 wherein the requested time for the liability transfer is a future time, wherein the plurality of available times for the liability transfer comprise at least one future date, wherein the selection of the at least one selected date for the liability transfer comprises the at least one future date.

21. The first electronic device of claim 18 further operable to:
if the first amount of liability equals the second amount of liability, determine the third amount of liability to be equal to the first amount of liability;
if the first amount of liability is greater than the second amount of liability, determine the third amount of liability to be equal to the second amount of liability; and
if the first amount of liability is less than the second amount of liability, determine the third amount of liability to be equal to the second amount of liability.

22. The first electronic device of claim 21 further operable to:
if the first amount of liability is not equal to the second amount of liability, transmit an indication of a verification error to the electronic device associated with the customer; and
if the first amount of liability is equal to the second amount of liability, transmit an indication of a verification success to the electronic device associated with the customer.

23. The first electronic device of claim 18 further operable to determine that the third amount of liability is the lesser of the first amount of liability and the second amount of liability minus an additional amount.

24. An electronic device associated with a provider to deposit funds from a provider's bank account to a customer's bank account operable to:
receive, from an electronic device associated with the customer, an on-demand liability transfer scheduling request for a liability pickup wherein the on-demand liability transfer scheduling request is associated with a pickup location and a first amount of liability;
obtain, by the provider and in response to the on-demand liability transfer scheduling request, a second amount of liability from the customer at the pickup location;
verify, by the electronic device associated with the provider, the first amount of liability with a second amount of liability, obtained by the provider and in response to the on-demand liability transfer scheduling request, to determine a third amount of liability; and
initiate a business-to-business (B2B) electronic payment from a first bank account associated with the provider to a second bank account associated with the customer for the third amount of liability.

25. The electronic device associated with the provider of claim 24 further operable to:
if the first amount of liability equals the second amount of liability, determine the third amount of liability to be equal to the first amount of liability;
if the first amount of liability is greater than the second amount of liability, determine the third amount of liability to be equal to the second amount of liability; and
if the first amount of liability is less than the second amount of liability, determine the third amount of liability to be equal to the first amount of liability.

26. The electronic device associated with the provider of claim 24 further operable to determine that the third amount of liability is the lesser of the first amount of liability and the second amount of liability minus an additional amount.

27. The electronic device associated with the provider of claim 24 further operable to determine whether the first amount of liability is equal to the second amount of liability wherein:
if the first amount of liability is not equal to the second amount of liability, transmit an indication of a verification error to the electronic device associated with the customer; and
if the first amount of liability is equal to the second amount of liability, transmit an indication of a verification success to the electronic device associated with the customer.

28. The electronic device associated with the provider of claim 24 further operable to transmit to the electronic device associated with the customer an indication of the B2B electronic payment.

29. An electronic device associated with a provider for processing a liability change order from a customer operable to:
receive, from an electronic device associated with the customer over one or more networks, an on-demand liability transfer scheduling request for delivery of a first amount of liability wherein the on-demand liability transfer scheduling request is associated with a delivery location for the delivery of the first amount of liability;
initiate a business-to-business (B2B) electronic payment from a first bank account associated with the customer to a second bank account associated with the provider for a second amount of liability; and
verify the first amount of liability with the second amount of liability to determine a third amount of liability to be delivered by the provider to the customer.

30. The electronic device associated with the provider of claim 29 further operable to determine that the third amount of liability is equal to the second amount of liability.

31. The electronic device associated with the provider of claim 29 further operable to determine that the third amount of liability is the second amount of liability minus an additional amount.

32. The electronic device associated with the provider of claim 29 further operable to determine whether the first amount of liability is equal to the second amount of liability wherein:
if the first amount of liability is not equal to the second amount of liability, transmit an indication of a verification error to the electronic device associated with the customer; and
if the first amount of liability is equal to the second amount of liability, transmit an indication of a verification success to the electronic device associated with the customer.

33. The electronic device associated with the provider of claim 29 further operable to transmit to the electronic device associated with the customer an indication of the B2B electronic payment.

34. The electronic device associated with the provider of claim 29 further operable to transmit to the electronic device associated with the customer an indication of the third amount of liability.
